(19) United States
(12) Patent Application Publication
(10) Pub. No.: US 2015/0008351 A1
(43) Pub. Date: Jan. 8, 2015

(54) BALL VALVE AND METHOD OF ASSEMBLING THE SAME

(71) Applicants: Thomas A. Hartman, St. Louis, MO (US); Brian T. Hartman, Mesa, AZ (US)

(72) Inventors: Thomas A. Hartman, St. Louis, MO (US); Brian T. Hartman, Mesa, AZ (US)

(21) Appl. No.: 13/934,885

(22) Filed: Jul. 3, 2013

(51) Int. Cl. F16K 5/06

(52) U.S. Cl. CPC F16K 5/0647
USPC 251/315.08; 29/890.124

(57) ABSTRACT

A ball valve has trunnions that comprise shaft portions and larger diameter bearing portions. The larger bearing portions ensure that bearing pressures will be low. Smaller shaft portions reduce material costs and minimize the overall size of the valves. Preferably the bearing portions are formed out of a different material than are the shaft portions. This allows the bearing portions to be formed out of a lower strength (and therefore lower cost) material. Conversely, it also allows the shaft portions to be formed out of a higher strength material to thereby minimize the size of the trunnion shafts without impacting the bearing size and cost. Additionally, each bearing portion is preferably a cylindrical sleeve and is preferably heat-shrunk around part of the shaft portion.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to large industrial valves for controlling the flow of fluids therethrough. More particularly, this invention pertains particularly to the trunnions that pivotally support valve plugs relative to the valve housings in which they are mounted.

2. General Background

Industrial valves of the type used in water or sewage treatment plants, as well as in other industries, preferably must remain fully operational for appreciably long periods of time. Additionally, it is preferable for such valves to be serviceable in situ.

Various styles of industrial valves include butterfly valves, sleeve valves, and ball valves. Some types of valves, such as butterfly valves and ball valves, comprise a pivotal plug/gate. Pivotal plugs are typically supported by the housing of the valve via a pair of coaxial trunnions that extend from opposite sides of the plug. One of the trunnions typically also serves as the drive shaft that is rotationally driven to control the rotational position of the plug within the housing and to thereby control the fluid flow through the valve. Valve housings typically comprise bushings for pivotally supporting the trunnions and some form of seals for preventing fluid from leaking through the housing around the trunnions.

It is preferable to configure the bearings of industrial valves such that the maximum bearing pressure will not exceed approximately 2000 psi (13.8 MPa). Unfortunately, this relatively low pressure requires rather large bearing diameters, and therefore large diameter trunnions. As a result, the trunnion diameters tend to be much larger than is needed to handle the driving torque for adjusting the valve. Larger trunnions result in larger valve housings, greater weight, and greater material costs.

### SUMMARY OF THE INVENTION

The present invention is directed to ball valves having trunnions that comprise shaft portions and larger diameter bearing portions. The larger bearing portions ensure that bearing pressures will be low. Smaller shaft portions reduce material costs and minimize the overall size of the valves. Preferably the bearing portions are formed out of a different material than are the shaft portions. This allows the bearing portions to be formed out of a lower strength (and therefore lower cost) material. Conversely, it also allows the shaft portions to be formed out of a higher strength material to thereby minimize the size of the trunnion shafts without impacting the bearing size and cost. Additionally, each bearing portion is preferably a cylindrical sleeve and is preferably heat-shrunk around part of the shaft portion.

In one aspect of the invention, a ball valve comprises a valve housing and a ball plug. The valve housing comprises an inner cavity. The ball plug is positioned within the inner cavity and comprises a main body portion and a pair of trunnions. The trunnions are fixed to the main body of the ball plug so as to pivot therewith and pivotally connect the ball plug to the valve housing. Each of the trunnions comprises a bearing portion and shaft portion. Each of the bearing portions encircles a respective one of the shaft portions and is fixed to said shaft portion via a cylindrical interference fit so as to pivot therewith.

Another aspect of the invention pertains to a method of assembling a ball valve having a ball plug and valve housing. The method comprises assembling a trunnion and attaching the ball plug to the valve housing via the trunnion. The trunnion comprises a cylindrical shaft portion and a bearing sleeve portion. The bearing sleeve portion comprises an annular bearing surface and a cylindrical opening. The annular bearing surface and the cylindrical opening are coaxial. The cylindrical opening has a first diameter and the shaft portion has a second diameter. The first diameter is less than the second diameter when the cylindrical shaft portion and the bearing sleeve portions are at equal temperatures. The assembly of the trunnion comprises causing the bearing sleeve portion to have a temperature above that of the shaft portion in a manner such that the first diameter becomes greater than the second diameter, thereafter extending the shaft portion through the cylindrical opening of the bearing sleeve portion while the first diameter is greater than the second diameter, and thereafter allowing the shaft portion and the bearing sleeve portion to reach an equal temperature to thereby form an interference connection between the bearing sleeve portion and the shaft portion. The valve housing comprises a trunnion bearing and the attaching of the ball plug to the valve housing comprises engaging the bearing sleeve portion of the trunnion with the trunnion bearing such that the trunnion and the ball plug are pivotally supported by the trunnion bearing.

Yet another aspect of the invention pertains to a method of assembling a ball valve. The ball valve comprises a ball plug and a valve body. The method comprises attaching a bearing sleeve to a trunnion shaft via an interference fit. The bearing sleeve and the trunnion shaft are configured and adapted to at least partially pivotally attach the ball plug of the ball valve to the valve body. The interference fit between the trunnion shaft and the bearing sleeve rotationally and axially fixes the bearing sleeve to the trunnion shaft.

Further features and advantages of the present invention, as well as the operation of the invention, are described in detail below with reference to the accompanying drawings.

### BRIEF DESCRIPTION OF THE DRAWINGS

FIG. 1 depicts a cutaway perspective view of a ball valve in accordance with the invention (showing the front, top, and left sides thereof) with its valve body partially removed to reveal the valve's ball plug in the open position.

FIG. 2 depicts a similar cutaway perspective view of the ball valve shown in FIG. 1 with its ball plug in the closed position.

FIG. 3 depicts a cross-section of the ball valve shown in FIGS. 1 and 2, taken about a horizontal plane passing thought the axis of the trunnions.

FIG. 4 is an exploded perspective view of one of said ball valve's trunnions.

FIG. 5 is an exploded perspective view of said ball valve's ball plug, showing the trunnions detached from the main body of the ball plug.

Reference numerals in the written specification and in the drawing figures indicate corresponding items.

### DETAILED DESCRIPTION

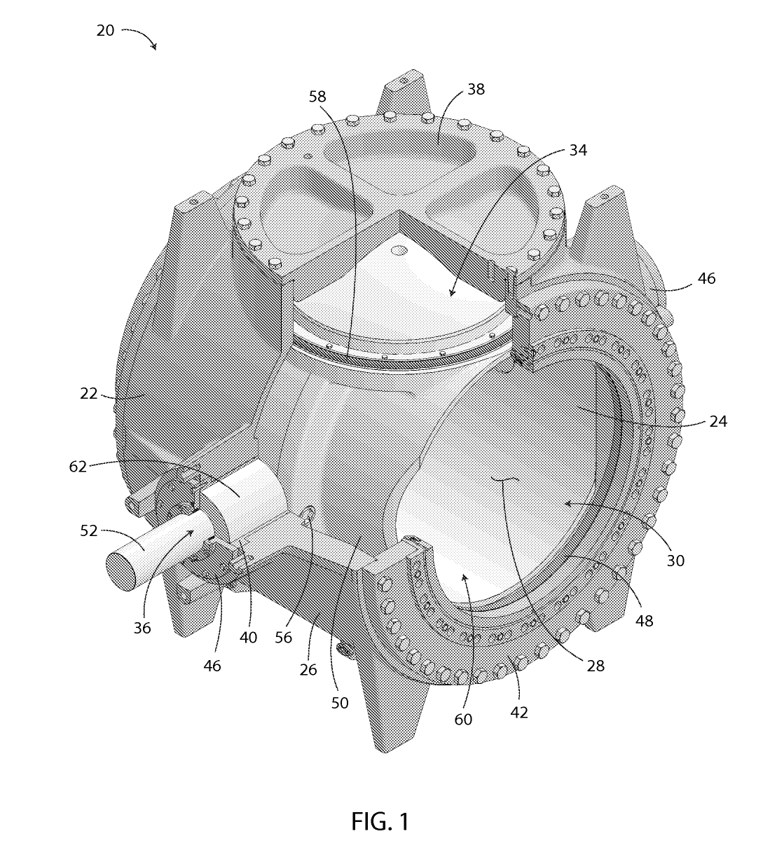

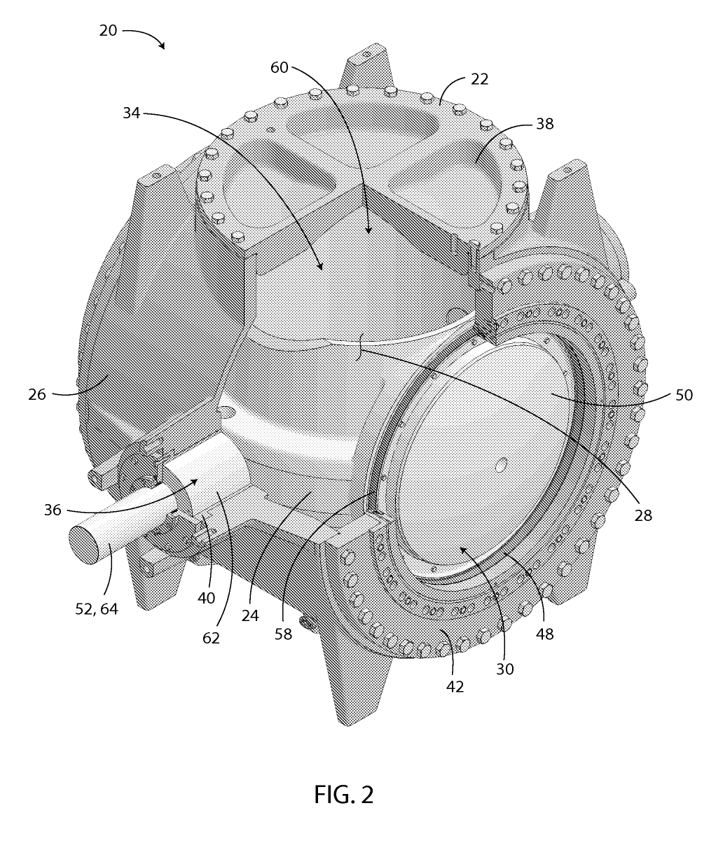

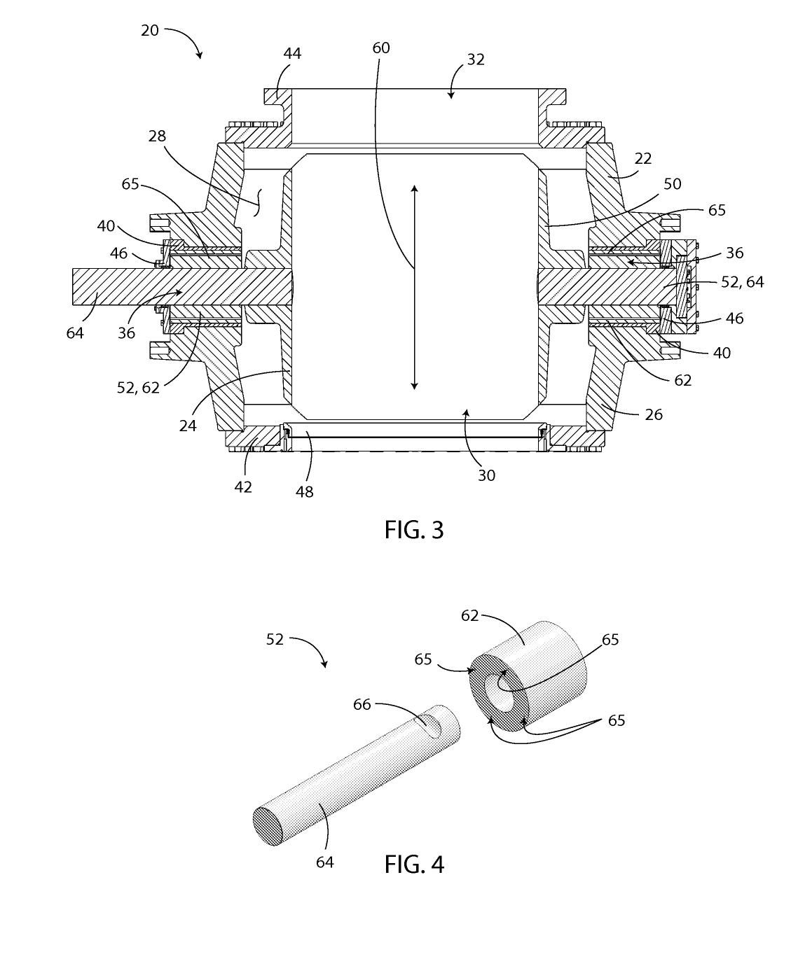

A ball valve in accordance with the invention is shown in FIGS. 1-3, as indicated by reference numeral 20. The ball valve 20 comprises a housing 22 and a ball plug 24. The ball plug 24 is pivotally mounted within and relative to the housing 22 about an axis such that the ball plug can pivot between a fully opened position and a fully closed position. When the ball plug 24 is in the opened position, fluid is permitted to flow unobstructed through the ball valve 20 and ball plug. Conversely, when the ball plug 24 is in the closed position, the ball plug prevents fluid from flowing through the ball valve 20.

The housing 22 comprises a generally cylindrical and tubular valve body 26 that is preferably formed as a monolithic part. The valve body 26 comprises a cavity 28, opposite front and rear fluid openings 30, 32, a plug seal replacement port 34, and a pair of axially aligned trunnion openings 36. The plug seal replacement port 34 preferably extends through the top of the valve body 26 to provide access to the cavity 28. The trunnion openings 36 preferably define a horizontally oriented axis that lies directly beneath the plug seal replacement port 34.

The housing 22 also comprises a plug seal replacement port cover 38, trunnion bearings 40, and front and rear ring-flanges 42, 44, and trunnion seal rings 46. The plug seal replacement port cover 38 is bolted over the plug seal replacement port 34 to close the port during normal operation, but can be removed when access to the cavity 28 of the valve body 26 is desired. The trunnion bearings 40 are bushing-style bearings that are configured to be inserted into the trunnion openings 36 of the valve body 26 and bolted to the valve body from outside the valve body. The trunnion seal rings 46 are bolted to the trunnion bearings 40 and are configured to seal against trunnions to prevent fluid from leaking out of the valve 20 through the trunnion openings 36. The front and rear ring-flanges 42, 44 are aligned with and bolted to the front and rear fluid openings 30, 32, respectively, and provide means for attaching the valve 20 in-line between pipes of a fluid system. Additionally, the front ring-flange 42 comprises a removable annular valve seat 48 that is configured to seal against a valve seat of the ball plug 24 (described below) to prevent fluid from passing through the valve 20 when the ball plug is in the closed position.

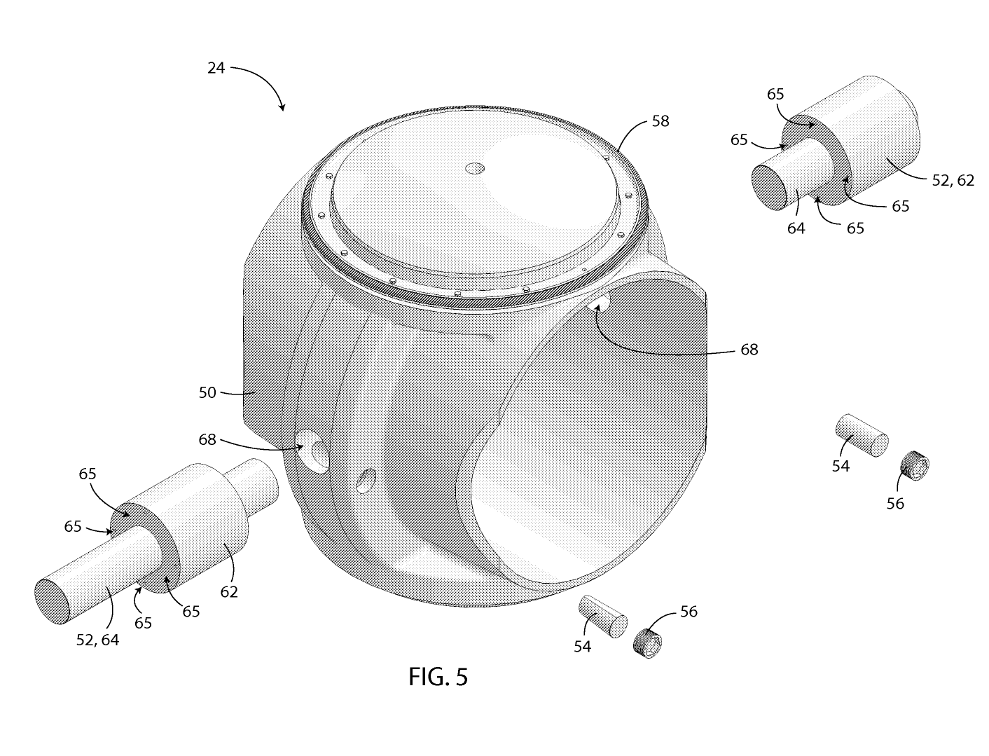

The ball plug 24 assembly is shown in an exploded view in FIG. 5 and comprises a main body portion 50, a pair of trunnions 52, locking pins 54, set-screws 56, and an annular valve seat 58. A generally cylindrical fluid passageway 60 extends through the main body portion 50 and preferably has a diameter equal or greater to the inner diameter of the pipes (not shown) of the fluid system to which the valve is configured to be attached. The valve seat 58 is removably attached to the outer surface of the main body portion 50 between the axial ends of the fluid passageway 60. The trunnions 52 each comprise a cylindrical bearing portion 62 and cylindrical shaft portion 64. The bearing portions 62 have a diameter greater than that of the shaft portions 64 and preferably comprise a plurality of axial pressure equalizing through-holes 65. The shaft portions 64 of the trunnions 52 each comprise a traverse semi-cylindrical keyway 66. The shaft portions 64 are dimensioned to slide into cylindrical holes 68 formed in the main body portion 50 of the ball plug 24 and be secured thereto via the trunnion keyways 66, tapered locking pins 54, and set-screws 56 in the manner similar to that which is described in U.S. Pat. No. 4,579,477 (which is hereby incorporated by reference in its entirety).

As mentioned above, the trunnions 52 of the ball plug 24 each comprise a cylindrical bearing portion 62 and cylindrical shaft portion 64. Preferably those portions are initially fabricated as separate components, as shown in FIG. 4. Forming those portions as separate components eliminates the machining and/or forging that would be required to form each trunnion 52 as a monolithic part. Additionally, standards in the industry require trunnion bearing pressures in differential pressure valves to be approximately 2000 psi (13.8 MPa) or lower, so as to avoid rapid wear of the trunnion bearings 40 of the housing 22 of the valve 20. To achieve that relatively low pressure, the diameter of the bearing portions 62 of the trunnions 52 must be larger than is needed simply to torsionally drive the ball plug 24 relative to the housing 22. Moreover, although the trunnions 52 could simply be cylindrical and have said rather large diameter throughout their length (to eliminate the machining/forging discussed above), configuring the trunnions in that manner would require more material than is needed and would increase the size of the trunnion holes 68 of the main body portion 50 of the ball plug 24, thereby increasing the cost and size of the ball valve 20.

Forming cylindrical bearing portions 62 and cylindrical shaft portions 64 of the trunnions 52 as separate parts has additional advantages. The low required bearing pressure discussed above is well below the yield strength of most metals and therefore the cylindrical bearing portions are preferably formed out of relatively low cost metals such as 304 stainless. Conversely, the shaft portions 64 can preferably be formed out of a stronger material, such as 17-4 stainless, which, although more expensive per pound, allows the shaft portions to be formed out of relatively little material (i.e., with a relatively small diameter).

The bearing portions 62 of the trunnions 52 are preferably formed as cylindrical sleeves having an inner diameter that is slightly less than the outer diameter of the shaft portions 64 to thereby create an interference fit between said components when they are joined. Although the bearing portions 62 could be press-fit over the shaft portions 64, the bearing portions are preferably heat shrunk to the shaft portions using any method involving heating the bearing portions and/or cooling the shaft portions. The interference fit locks the bearing portions 62 to the shaft portions 64 and prevents and fluid from passing therebetween.

The ball valve 20 is assembled by inserting the main body portion 50 of the ball plug 24 into the valve body 26 of the housing 22 through either the front or rear fluid openings 30, 32 of the valve body. The trunnions 52 are thereafter inserted through the trunnion openings 36 of the valve body 26 of the housing 22 from outside the valve body, and the ends of the shaft portions 64 of the trunnions are then secured into the trunnion holes 68 of the main body portion 50 of the ball plug 24 via the locking pins 54 and set screws 56. The trunnion bearings 40 of the valve body 26 of the housing 22 are also inserted into the trunnion openings 36 from outside the valve body. The other components are then assembled to the valve 20.

When the valve seat 58 of the ball plug 24 is in need of replacement, it can be replaced via the seal replacement port 34 of the housing 22 (with the ball plug 24 in the open position) without disconnecting the valve 20 from the pipes (not shown) to which the valve is assembled. Similarly, worn trunnion bearings 40 can be replaced by removing the trunnion seals 46 of the housing 22 and thereafter extracting the worn trunnion bearings from outside the housing. It should also be appreciated that, in use, the pressure equalizing through holes 65 of the bearing portions 62 of the trunnions 52 allow fluid pressures on the axially opposite sides of said bearing portions to equalize. This prevents such fluid pressures from exerting side loads on the ball plug 24 relative to the housing 22. Additionally, although the valve 20 is adapted to be driven by only the longer of the trunnions 52, it can, if necessary, be driven by the other of the trunnions.

In view of the foregoing, it should be appreciated that the invention has several advantages over the prior art.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed, unless such an order is inherent.

What is claimed is:

1. A ball valve comprising a valve housing and a ball plug, the valve housing comprising an inner cavity, the ball plug being positioned within the inner cavity and comprising a main body portion and a pair of trunnions, the trunnions being fixed to the main body of the ball plug so as to pivot therewith and pivotally connecting ball plug to the valve housing, each of the trunnions comprising a bearing portion and shaft portion, each of the bearing portions encircling a respective one of the shaft portions and being fixed to said shaft portion via a cylindrical interference fit so as to pivot therewith.

2. A ball valve in accordance with claim 1 wherein the bearing portions of the trunnions are formed out of a material having first compressive yield strength and the shaft portions of the trunnions are formed out of another material having a second compressive yield strength, the first compressive yield strength being less than the second compressive yield strength.

3. A ball valve in accordance with claim 2 wherein each of the shaft portions is fixed to the main body of the ball plug via a tapered locking pin.

4. A ball valve in accordance with claim 3 wherein the valve housing comprises a monolithic valve body that encircles the inner cavity and the ball plug.

5. A ball valve in accordance with claim 4 wherein the ball valve comprises a pair of trunnion bushings that are replaceable from outside the valve housing, each of the trunnion bushings being engaged with the bearing portion of a respective one of the trunnions to thereby pivotally support the ball plug relative to the valve housing.

6. A ball valve in accordance with claim 1 wherein each of the bearing portions comprises at least one axial through-hole that is adapted and configured to equalize pressure on axially opposite sides of said bearing portion.

7. A method of assembling a ball valve having a ball plug and valve housing, the method comprising:
assembling a trunnion, the trunnion comprising a cylindrical shaft portion and a bearing sleeve portion, the bearing sleeve portion comprising an annular bearing surface and a cylindrical opening, the annular bearing surface and the cylindrical opening being coaxial, the cylindrical opening having a first diameter, the shaft portion having a second diameter, the first diameter being less than the second diameter when the cylindrical shaft portion and the bearing sleeve portions are at equal temperatures, the assembling of the trunnion comprising causing the bearing sleeve portion to have a temperature above that of the shaft portion in a manner such that the first diameter becomes greater than the second diameter, thereafter extending the shaft portion through the cylindrical opening of the bearing sleeve portion while the first diameter is greater than the second diameter, and thereafter allowing the shaft portion and the bearing sleeve portion to reach an equal temperature to thereby form an interference connection between the bearing sleeve portion and the shaft portion;
attaching the ball plug to the valve housing via the trunnion, the valve housing comprising a trunnion bearing, the attaching of the ball plug to the valve housing comprising engaging the bearing sleeve portion of the trunnion with the trunnion bearing such that the trunnion and the ball plug are pivotally supported by the trunnion bearing.

8. A method in accordance with claim 7 wherein the bearing sleeve portion is heated to cause the bearing sleeve portion to have the temperature above that of the shaft portion.

9. A method in accordance with claim 7 wherein the bearing sleeve portion is formed out of a material having a first compressive yield strength and the shaft portion of the trunnions is formed out of another material having a second compressive yield strength, the first compressive yield strength being less than the second compressive yield strength.

10. A method in accordance with claim 7 wherein the bearing sleeve portion comprises at least one axial through-hole that is adapted and configured to equalize pressure on axially opposite sides of the bearing sleeve portion.

11. A method of assembling a ball valve, the ball valve comprising a ball plug and a valve body, the method comprising:
attaching a bearing sleeve to a trunnion shaft via an interference fit, the bearing sleeve and the trunnion shaft being configured and adapted to at least partially pivotally attach the ball plug of the ball valve to the valve body, the interference fit between the trunnion shaft and the bearing sleeve rotationally and axially fixing the bearing sleeve to the trunnion shaft.

12. A method of assembling a ball valve in accordance with claim 11 wherein the trunnion shaft is formed of a material having a first tensile strength and the bearing sleeve is formed of another material having a second tensile strength, and the first tensile strength is greater than the second tensile strength.

13. A method of assembling a ball valve in accordance with claim 11 wherein the bearing sleeve is heat shrunk onto the trunnion shaft.

14. A method of assembling a ball valve in accordance with claim 11 wherein the bearing sleeve comprises at least one axial through-hole that is adapted and configured to equalize pressure on axially opposite sides of the bearing sleeve.
